(19) United States
(12) Patent Application Publication
(10) Pub. No.: US 2020/0021376 A1
(43) Pub. Date: Jan. 16, 2020

(54) INTEGRATED CONTENT-PRODUCTION SYSTEM

(71) Applicant: Weather Group Television, LLC, Atlanta, GA (US)

(72) Inventors: James Thomas, Atlanta, GA (US); Michael Chesterfield, Smyrna, GA (US); Michael Smereski, Kennesaw, GA (US); Fredric Flaxman, Los Angeles, CA (US); Craig McMahon, Gainesville, GA (US); Dennis Nesbit, Atlanta, GA (US)

(21) Appl. No.: 16/218,606

(22) Filed: Dec. 13, 2018

Related U.S. Application Data
(60) Provisional application No. 62/697,809, filed on Jul. 13, 2018.

(51) Int. Cl. H04H 60/07; H04H 60/04; H04H 60/72; H04N 21/2187; H04N 21/266; H04N 21/482

(52) U.S. Cl. CPC H04H 60/07; H04H 60/04; H04N 21/482; H04N 21/2187; H04N 21/266; H04H 60/72

(57) ABSTRACT

Certain embodiments involve an integrated content-production system. In one example, an integrated content-production system can include a video camera, an operator station, and a presenter station. The operator station can include a source control device communicatively coupled to a set of content sources and the video camera. The source control device can be used to switch among an output of the video camera and the set content sources for transmission of content to target devices. The presenter station can include a content display device communicatively coupled to the video camera and the set of content sources. The presenter station can also include a touchscreen device that presents a source-selection interface. The source-selection interface can have scrollable rows of interface elements for switching among the output of the video camera and the set content sources for transmission of content to one or more target devices.

### CROSS-REFERENCE TO RELATED APPLICATIONS

This disclosure claims priority to U.S. Provisional Application No. 62/697,809, filed on Jul. 13, 2018, which is hereby incorporated in its entirety by this reference.

### TECHNICAL FIELD

The present disclosure relates generally to devices and operations for controlling the presentation of display data for distribution over data networks. More specifically, but not by way of limitation, this disclosure relates to an integrated content-production system used by, for example, a television studio or other system for providing multimedia content over one or more communication networks.

### BACKGROUND

Interactive video distribution processes and systems are used for the distribution or delivery of media content, such as video data, from operators (e.g., access or service providers) to end users (e.g., subscriber devices). For instance, a television distribution system can distribute or deliver motion video data or other data to end-user devices, such as cable boxes, antennas, mobile computing devices, etc. Content production systems are used to generate, assemble, or otherwise prepare content for delivery via a video distribution system. For instance, a content production system can include various transmitter elements and computing elements for facilitating the dynamic control of media content preparation, processing, and/or distribution.

### BRIEF DESCRIPTION OF THE DRAWINGS

Features, embodiments, and advantages of the present disclosure are better understood when the following Detailed Description is read with reference to the drawings.

FIG. 1 depicts an integrated content-production system, according to certain embodiments of the present disclosure.

FIG. 2 depicts an example of a source-selection interface used by a touchscreen device in the integrated content-production system of FIG. 1, according to certain embodiments of the present disclosure.

FIG. 3 depicts an example of the source-selection interface depicted in FIG. 2 being updated by a scrolling input, according to certain embodiments of the present disclosure.

FIG. 4 depicts an example of a thumbnail generation workflow for updating the source-selection interface depicted in FIGS. 2 and 3, according to certain embodiments of the present disclosure.

FIG. 5 depicts an example of a video-on-demand conversion workflow that can be used by the thumbnail generation depicted in FIG. 4, according to certain embodiments of the present disclosure.

FIG. 6 depicts an example of an operating environment that includes components of the integrated content-production system being operated using the thumbnail generation workflow depicted in FIG. 4, according to certain embodiments of the present disclosure.

FIG. 7 depicts an example of a computing system for implementing certain embodiments described in the present disclosure.

### DETAILED DESCRIPTION

This disclosure involves an integrated content-production system that can be used in, for example, a television studio or other provider of content over one or more communication networks. The integrated content-production system can include a set of devices that are configured for allowing for the production of content (e.g., information-based television programming) with a smaller number of personnel (e.g., 1-2 personnel) than existing systems.

In one example, an integrated content-production system can include a video camera, an operator station, and a presenter station. The operator station can include a source control device communicatively coupled to a set of content sources and the video camera. The source control device can be used to switch among an output of the video camera and the set content sources for transmission of content to target devices. The presenter station can include a content display device communicatively coupled to the video camera and the set of content sources. The presenter station can also include a touchscreen device that presents a source-selection interface.

In some embodiments, the source-selection interface can have scrollable rows of interface elements for switching among the output of the video camera and the set content sources for transmission of content to one or more target devices. For instance, the source-selection interface can include multiple rows of interface elements, such as thumbnail images, that respectively correspond to different content sources. Each row of interface elements could be scrollable along a particular axis (e.g., a horizontal axis) and constrained so that the row and/or interface elements within the row are not movable in another direction (e.g., along a vertical axis). A presenter computing device can receive a selection of a given interface element via the source-selection interface and switching to a corresponding content source for transmission of media content from the selected content sources to the one or more target devices.

Examples of Integrated Content-Production System Elements

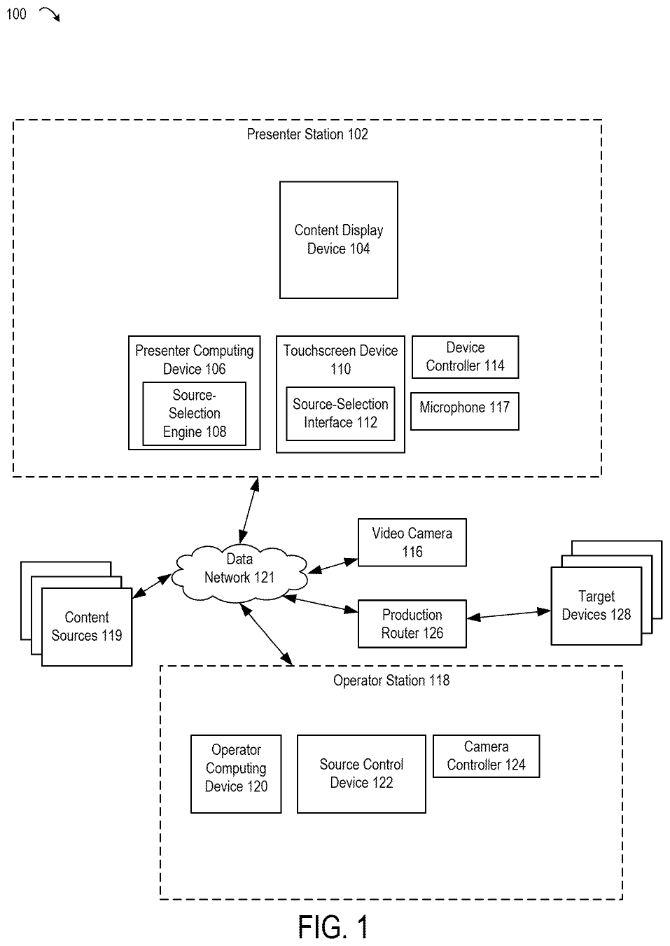

FIG. 1 depicts an integrated content-production system 100, according to certain embodiments of the present disclosure. In some embodiments, a studio space in which the integrated content-production system 100 is implemented can be organized in a layout similar to that depicted in FIG. 1. But other implementations are possible in which at least some of the same components depicted in FIG. 1 are organized in a layout that differs from the example of FIG. 1

The integrated content-production system 100 can include a presenter station 102, a video camera 116, and an operator station 120. The video camera 116, some or all devices of the presenter station 102, and/or some or all devices of the operator station 118 are communicatively coupled together via a data network 121. The data network 121 can include one or more routers, buses, or other communication equipment or circuitry for relaying signals between the devices of the integrated content-production system 100. In some embodiments, the data network 121 is a local area network or other network configured for short-range communication.

One or more devices of the integrated content-production system 100 can also be communicatively coupled to one or more target devices 128 via one or more production routers 126. A production router 126 can be a device that transmits created content to end-user devices, distribution networks, or some combination thereof. A production router 126 can be a device included in or communicatively coupled to a wide-area network or other network configured for long-range communication. A target device 128 can be an end user device (e.g., a mobile computing device, a television, etc.), a device in a video distribution network (e.g., a server of a multichannel video programming distributor, etc.), or some combination thereof.

The presenter station 102 can include a content display device 104, a presenter computing device 106 that executes a source-selection engine 108, a touchscreen device 110 for presenting and interacting with a source-selection interface 112, a device controller 114, and a microphone 117. The operator station 118 can include an operator computing device 120, a source control device 122, and a camera controller 124.

The integrated content-production system 100 can include one or more devices (e.g., a source control device 122, one or more devices of the presenter station 102, etc.) that switch between different content sources 119 to be transmitted via the production router 126 to target devices 128. Examples of content sources 119 include one or more remotely located video cameras, an online content service, a non-transitory computer-readable medium having media assets stored thereon, etc. For instance, the transmitted content could be an output of the video camera 116, a live feed from a remote camera or website included in a set of content sources 119, and one or more still images included in the set of content sources 119, etc.

For instance, one or more of the presenter computing device 106 and the operator computing device 120 can execute control code. An example of control code includes software used for content curation, content playback, control of interactions by a touch screen monitor or other input device, or some combination thereof. An example of this software is the source-selection engine 108. Instances of the source-selection engine 108 can be executed on the presenter computing device 106, the operator computing device 120, or both.

The source-selection engine 108, when executed, controls the source-selection interface 112, which is a graphical interface. The source-selection interface 112 can be used by one or more individuals, such as on-camera talent located at the presenter station 102, to select content for presentation on the content display device 104. Examples of this content include, but are not limited to, recorded videos, live video sources, graphical maps, etc. In some embodiments, the source-selection interface 112 is presented on a touchscreen device 110. In some embodiments, the touchscreen device 110 can include one or more capabilities for telestrating.

The device controller 114 can be used to send commands to another device in the integrated content-production system 100. For instance, device controller 114 can include a general purpose interface (“GPI”). The GPI-based device controller 114 allows the device controller 114 to send commands to certain devices.

In some embodiments, a GPI-based device controller 114 can transmit commands to various devices via the operator computing device 120. For instance, a GPI-based device controller 114 can transmit, to the operator computing device 120, a camera movement command or other command involving the video camera 116. The operator computing device 120 can relay the command to the video camera 116, thereby controlling operation to the video camera 116.

In additional or alternative embodiments, a GPI-based device controller 114 can transmit commands to various devices directly, such as a command to the video camera 116 causing the video camera 116 to change positions, a command to the video camera 116 causing the video camera 116 to start or stop capturing and/or transmitting video data, a command to the microphone 117 causing the microphone 117 to start or stop capturing and/or transmitting audio data, etc. The GPI allows the device controller 114 to receive messages from other devices, such as a commands or status data received from a presenter computing device 106. In some embodiment, the device controller 114 is a push-button controller.

The operator station 118 can allow an operator to perform one or more control operations. Examples of control operations may include managing electronic content for the on-camera display, controlling one or more robotic cameras included in (or communicatively coupled to) the integrated content-production system, adjusting audio levels, selecting program video sources feeding to a master control module, etc. In some embodiments, the operator station 118 can include or be included in a consolidated production control room.

The source control device 122 can enable changing audio source, video sources, or some combination thereof used in the composite output of the system. For example, the source control device 122 can include software, hardware, or both for combining various media assets, such as live video feeds, broadcast graphics, virtual sets, special effects, audio mixing, recording, social media publishing and web streaming. The source control device 122 can select certain media-capture devices (e.g., a video camera 116, a microphone 117), certain computer-readable media (e.g., a media asset repository accessible via the operator computing device 120), and/or other devices as inputs to a content-production process.

The camera controller 124 can be used to control one or more video cameras 116. The camera controller 124 is communicatively coupled to one or more video cameras 116. Commands transmitted by the camera controller 124 can cause the video camera 116 to change positions, to start or stop capturing video data, to start or stop transmitting video data to other devices in the integrated content-production system 100, etc.

In some embodiments, the integrated content-production system can allow for high quality informative programming to be produced with a minimal staff of one operator and one on-camera talent. For example, the integrated content-production system can reduce the need for a studio production workflow involving a control room with a crew of 6-7 technical staff, 1-2 producers and on-camera talent. With the differences in programming and production level from one hour to the next or on occasions where the programming is unplanned (e.g., severe weather coverage), the complexity of resources necessary may not require full staff. Unplanned programming can be produced with a streamlined production level. The integrated content-production system can allow, in some cases, a crew of two people to manage the same roles as the production methods that would otherwise involve 6-9 total staff. Examples of functions performed using the integrated content-production system may include ingesting or otherwise managing presentation of one or more of maps, animations, videos, photos and other live or recorded material, thereby making this content available for the on-camera talent to play via touch screen in a smooth fluid motion. For instance, a producer/operator can have control of video sources and audio levels before a signal is sent to a master control for air or recording.

In some embodiments, the integrated content-production system can enable the presentation of non-linear, presenter-driven content. The integrated content-production system can be a standalone production tool or integrated into traditional broadcasts. The integrated content-production system allows a single presenter to choose content, in any order, from a front-end user interface displayed via a single touchscreen monitor or duplicate, smaller, touchscreen monitors.

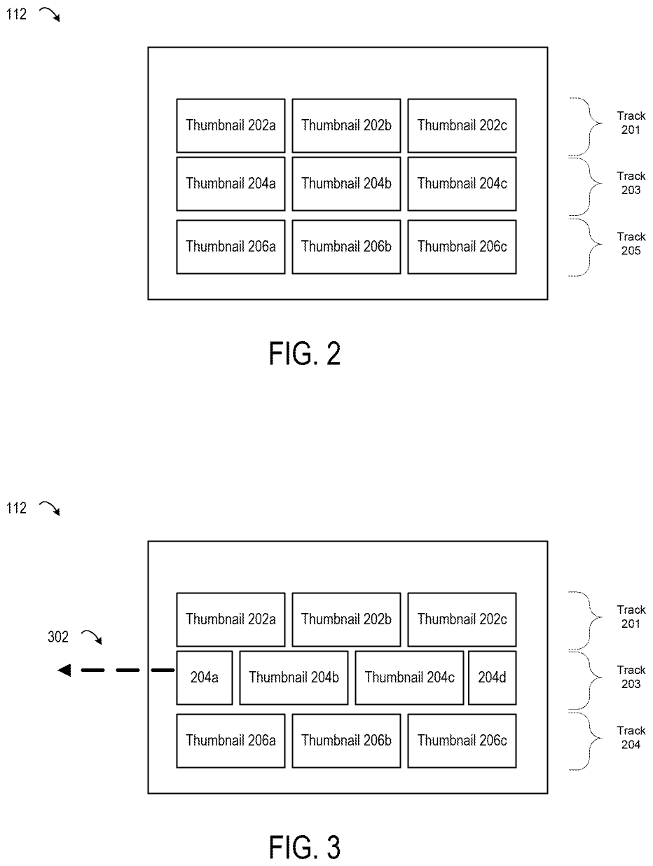

FIG. 2 depicts an example of a source-selection interface used by a touchscreen device in the integrated content-production system 100, according to certain embodiments of the present disclosure. In some embodiments, the source-selection interface 112 includes fixed tracks 201, 203, and 205. Each track is a scrollable row of interface elements for switching among a set of content sources, such as an output of the video camera 116 and various other content sources 119 (e.g., an image repository having image assets, a live feed from a remote camera, etc.). One example of an interface element in a scrollable track is a thumbnail.

For instance, as depicted in the example of FIG. 2, the track 201 includes multiple thumbnails 202a-c (e.g., still images, low-resolution videos, windows, or other graphical elements) corresponding to different content sources. The track 203 includes multiple thumbnails 204a-c (e.g., still images, low-resolution videos, windows, or other graphical elements) corresponding to different content sources. The track 205 includes multiple thumbnails 206a-c (e.g., still images, low-resolution videos, windows, or other graphical elements) corresponding to different content sources.

In some embodiments, each of the tracks 201, 203, and 205 is scrollable across a screen along one axis. Movement of the thumbnails 202a-c, 204a-c, and 206a-c may be constrained to the axis (e.g., movement in only a horizontal direction along a track or movement in only a vertical direction along a track). For instance, FIG. 3 depicts an example of the source-selection interface 112 being updated by a scrolling input 302. The scrolling input 302, depicted as a leftward arrow, could involve swiping or dragging a finger or stylus across the touchscreen device 110. The source-selection engine 108 or other executed control code responds to the scrolling input 302 by moving thumbnails 204a-c from track 203 in a leftward direction. Moving the thumbnails 204a-c from track 203 in a leftward direction causes the source-selection interface 112 to be updated such that the size of thumbnail 204a is reduced and the remaining space is occupied by a portion of a newly presented thumbnail 204d, which represents another content source.

Selecting one of the thumbnails in the source-selection interface 112 can cause the corresponding content source to be maximized or otherwise enlarged. For instance, the source-selection engine 108 or other executed control code responds to a selection input, such as tapping input received by the touchscreen device 110 at the position of a particular thumbnail, by selecting the corresponding content source (e.g., a particular camera, a particular live stream, a particular still image). The source-selection engine 108 or other executed control code configures the content display device 104 to display the selected content source. Additionally or alternatively, the source-selection engine 108 or other executed control code configures one or more routers, which can be communicatively coupled to the presenter computing device 106, to transmit media from the selected content source over a communication network as a main content feed.

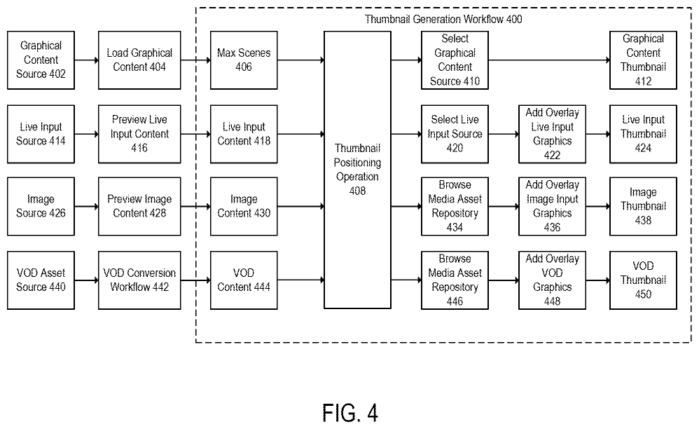

FIG. 4 depicts an example of a thumbnail generation workflow 400 for updating the source-selection interface 112. The thumbnail generation workflow 400 can be used to generate thumbnails based on different content sources. Examples of content sources include a graphical content source 402, a live input source 414, image source 426, and a video-on-demand (“VOD”) asset source 440.

A graphical content source 402 can include one or more sets of interactive graphics, one or more sets of non-interactive presentation graphics, or some combination thereof. An example of a graphic asset provided by the graphical content source 402 is a dynamic augmented reality package that includes three-dimensional images of storms and traffic events. An operation 404 performed by the source-selection engine 108 loads one or more graphical content assets from the graphical content source 402 into the thumbnail generation workflow. A thumbnail positioning operation 408 performed by the source-selection engine 108 identifies a track in which one or more loaded graphical content assets are to be displayed and a position within the track in which one or more loaded graphical content assets are to be displayed. A select graphical content source operation 410 can generate a graphical content thumbnail 412 from a loaded graphical content asset. For instance, the select graphical content source operation 410 can select a frame from a sequence of graphics, a title graphic included with the sequence of graphics, or any other suitable visual element that represents a loaded graphical content asset. The select graphical content source operation 410 can modify or generate a source-selection interface 112 that includes one or more tracks having one or more thumbnails representing loaded graphical content assets.

A live input source 414 can be any device that provides access to a live video feed. Examples of a live video feed include a feed from a video camera 116 received via a router, a feed from a remotely located camera received via a router or long-range communication network, a livestream from a website or social media platform, etc.

The source-selection engine 108 can perform various operations for generating a thumbnail or other representative visual element from a live input asset. For instance, an operation 416 performed by the source-selection engine 108 loads one or more live input assets from the live input source 414 into the thumbnail generation workflow 400, can preview one or more live input assets from the live input source 414 for selection by the thumbnail generation workflow 400, or some combination thereof. A thumbnail positioning operation 408 performed by the source-selection engine 108 identifies a track in which one or more loaded live input assets are to be displayed and a position within the track in which one or more loaded live input assets are to be displayed. A select live input source operation 420 can be used to generate a live input thumbnail 424 from a loaded live input asset. For instance, the select live input source operation 420 can select a frame from a live feed or other suitable visual element that represents the live feed. The select live input source operation 420 can modify or generate a source-selection interface 112 that includes one or more tracks having one or more thumbnails representing loaded live input assets.

In some embodiments, an operation 422 for adding overlay live input graphics can select relevant overlay graphics and apply them to the selected live input asset. These overlay graphics can include, for example, editorial information. For instance, if an asset from a live input source 414 is used, an overlay graphic can identify a location depicted by the asset, a source of the asset, or other information that should be included when the asset is presented on the content display device 104. If the loaded live input asset is selected via the source-selection interface 112, the loaded live input asset can be presented with the overlay graphics (e.g., editorial graphics).

An image source 426 can be any device that provides access to one or more images. For instance, an image source 426 can be a non-transitory computer-readable medium locally accessible by the presenter computing device 106 via a data bus, a non-transitory computer-readable medium accessible by the presenter computing device 106 via a local area network, an online image repository available from a website or social media platform, etc.

The source-selection engine 108 can perform various operations for generating a thumbnail or other representative visual element from an image asset. For instance, an operation 428 performed by the source-selection engine 108 loads one or more image assets from the image source 426 into a media asset repository used by the thumbnail generation workflow 400, can preview one or more image assets from the image source 426 for selection by the thumbnail generation workflow 400, or some combination thereof. A thumbnail positioning operation 408 performed by the source-selection engine 108 identifies a track in which one or more loaded image assets are to be displayed and a position within the track in which one or more loaded image assets are to be displayed. A browse media asset repository operation 434 can be used to generate an image thumbnail 438 from a loaded image asset. For instance, the browse media asset repository operation 434 can select a low-resolution version of the image asset or select another suitable visual element that represents the image asset. The thumbnail generation workflow 400 can thereby modify or generate a source-selection interface 112 that includes one or more tracks having one or more image thumbnails 438 representing loaded image assets.

In some embodiments, an operation 436 for adding overlay image input graphics can select relevant overlay graphics (e.g., similar types of editorial or other graphics used for live assets) and apply them to the loaded image asset. If the loaded image asset is selected via the source-selection interface 112, the loaded image asset can be presented with the overlay graphics (e.g., editorial graphics).

The VOD asset source 440 can be a source of live or recorded video content. The source-selection engine 108 can perform various operations for generating a thumbnail or other representative visual element from an VOD asset. For instance, a VOD conversion workflow 442 performed by the source-selection engine 108 selects one or more VOD assets from the VOD asset source 440 and converts the selected VOD assets into a format for storage in a media asset repository used by the thumbnail generation workflow 400. A thumbnail positioning operation 408 performed by the source-selection engine 108 identifies a track in which one or more loaded VOD assets are to be displayed and a position within the track in which one or more loaded VOD assets are to be displayed. A browse media asset repository operation 446 can generate a VOD thumbnail 450 from a loaded VOD asset. For instance, the browse media asset repository operation 446 can select a frame from a VOD asset or select another suitable visual element that represents the VOD asset. The thumbnail generation workflow 400 can modify or generate a source-selection interface 112 that includes one or more tracks having one or more VOD thumbnails 450 representing loaded VOD assets.

In some embodiments, an operation 448 for adding overlay VOD graphics can select relevant overlay graphics (e.g., similar types of editorial or other graphics used for live assets or image assets) and apply them to the selected VOD asset. If the loaded VOD asset is selected via the source-selection interface 112, the loaded VOD asset can be presented with the overlay graphics (e.g., editorial graphics).

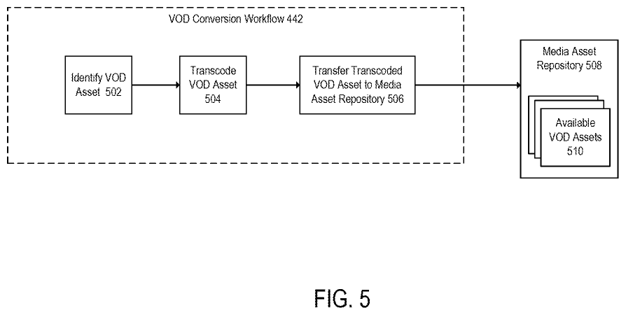

The VOD conversion workflow 442 can involve converting VOD assets from one or more VOD asset sources 440 to a format usable by the integrated content-production system 100. FIG. 5 depicts an example of a VOD conversion workflow 442. The VOD conversion workflow 442 can include an operation 502 for identifying a VOD asset, an operation 504 for transcoding the VOD asset, and an operation 506 for transferring the transcoded VOD Asset to a media asset repository 508. The media asset repository 508 can include one or more non-transitory computer-readable media storing suitable data structures for accessing, browsing, and/or retrieving one or more available VOD assets 510 for use by the thumbnail generation workflow 400.

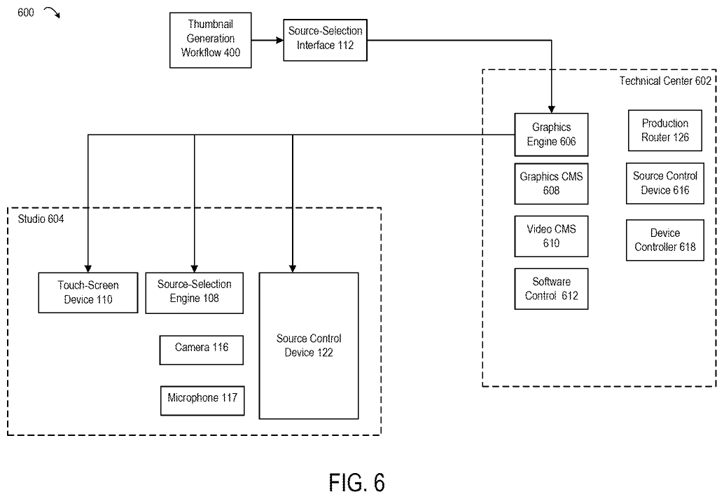

FIG. 6 depicts an example of an operating environment that includes components of the integrated content-production system being operated using the thumbnail generation workflow depicted in FIG. 4, according to certain embodiments of the present disclosure.

The technical center 602 can include various devices for executing software engines that support the content-production process. For instance, a computing device in the technical center 602 can execute one or more graphics engines 606 that are used to present and operate the source-selection interface 112 on the touchscreen device 110 within a studio 604. The computing device can also include a graphics content management system 608 for accessing different graphical content sources 402 in the set of content sources 119, a video content management system 610 for accessing different live input sources 414 and/or VOD asset sources 440 of the set of content sources 119, and a software control engine 612. The technical center 602 can also include one or more production routers 126, one or more source control devices 616 that can supplement or replace the operations of a source control device of the operator station 118, and one or more device controllers 618 that can supplement or replace the operations of a device controller of the presenter station 102.

Computing System Example

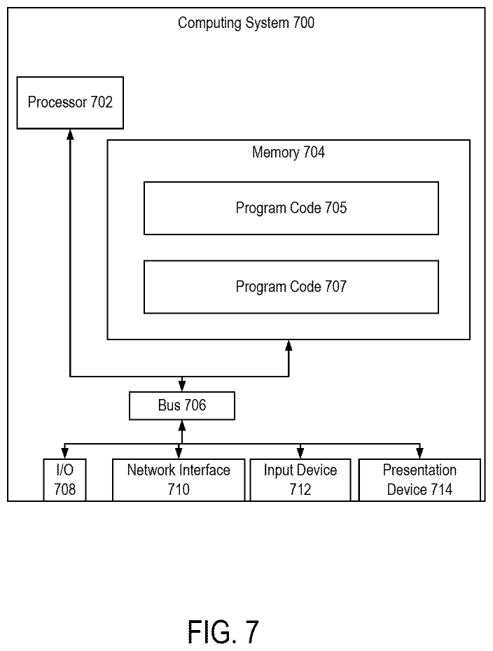

Any suitable computing system or group of computing systems can be used for performing the operations described herein. For example, FIG. 7 depicts an example of the computing system 700. The implementation of computing system 700 could be used for one or more control systems included in the integrated content-production system 100, such as a presenter computing device 106, an operator computing device 120, or a computing device that implements one or more operations of the technical center 602.

The depicted example of a computing system 700 includes a processor 702 communicatively coupled to one or more memory devices 704. The processor 702 executes computer-executable program code stored in a memory device 704, accesses information stored in the memory device 704, or both. Examples of the processor 702 include a microprocessor, an application-specific integrated circuit (“ASIC”), a field-programmable gate array (“FPGA”), or any other suitable processing device. The processor 702 can include any number of processing devices, including a single processing device.

The memory device 704 includes any suitable non-transitory computer-readable medium for storing program code 705, program data 707, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 700 may also include a number of external or internal devices, such as input or output devices. For example, the computing system 700 is shown with one or more input/output (“I/O”) interfaces 708. An I/O interface 708 can receive input from input devices 712 or provide output to output devices, such as a presentation device 714. One or more buses 706 are also included in the computing system 700. The bus 706 communicatively couples one or more components of a respective one of the computing system 700. Examples of input devices 712 include a touchscreen device 110, a device controller 114, a source control device 122, a camera controller 124, or other devices described herein that can be used to interact with one or more computing devices or control devices described above with respect to FIGS. 1-6.

The computing system 700 executes program code 705 that configures the processor 702 to perform one or more of the operations described herein. For example, the program code 705 could include control code. The program code may be resident in the memory device 704 or any suitable computer-readable medium and may be executed by the processor 702 or any other suitable processor.

The computing system 700 can access program data 707 (e.g., an input graphic or other electronic content) in any suitable manner. Examples of program data include various types of media assets, graphics, or other content described above with respect to FIGS. 1-6.

The computing system 700 also includes a network interface device 710. The network interface device 710 includes any device or group of devices suitable for establishing a wired or wireless data connection to one or more data networks. Non-limiting examples of the network interface device 710 include an Ethernet network adapter, a modem, etc. The computing system 700 is able to communicate with one or more other computing devices via a data network using the network interface device 710. Examples of the data network include, but are not limited to, the internet, a local area network, a wireless area network, a wired area network, a wide area network, and the like.

In some embodiments, the computing system 700 also includes the presentation device 714 depicted in FIG. 7. A presentation device 714 can include any device or group of devices suitable for providing visual, auditory, or other suitable sensory output (e.g., a content display device 104). Non-limiting examples of the presentation device 714 include a touchscreen, a monitor, a speaker, a separate mobile computing device, etc. In some embodiments, the presentation device 714 can include a remote client-computing device that communicates with the computing system 700 using one or more data networks described herein. Other embodiments can omit the presentation device 714.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. An integrated content-production system comprising:
a video camera;
an operator station comprising:
a source control device communicatively coupled to a set of content sources and the video camera, the source control device configured for switching among an output of the video camera and the set content sources for transmission of content to one or more target devices; and
a camera controller; and
a presenter station comprising:
a content display device communicatively coupled to the video camera and the set of content sources; and
a touchscreen device configured to present a source-selection interface having scrollable rows of interface elements for switching among the output of the video camera and the set content sources for transmission of content to one or more target devices.

2. The integrated content-production system of claim 1, wherein the source-selection interface comprises a first row of first interface elements respectively corresponding to first content sources and a second row of second interface elements respectively corresponding to second content sources,
wherein the presenter station further comprises a presenter computing device configured for:
receiving a selection of one of the first interface elements via the source-selection interface,
switching to one of the first content sources corresponding to the one of the first interface elements for transmission of first content from the one of the first content sources to the one or more target devices,
receiving a selection of one of the second interface elements via the source-selection interface, and
switching to one of the second content sources corresponding to the one of the second interface elements for transmission of second content from the one of the second content sources to the one or more target devices.

3. The integrated content-production system of claim 2, wherein each of the first row of first interface elements and the second row of second interface elements is scrollable along a horizontal axis and is not movable in a vertical direction.

4. The integrated content-production system of claim 1, further comprising a device controller configured for transmitting commands to one or more of the video camera and the operator station.

5. The integrated content-production system of claim 1, wherein the operator station and the presenter station are communicatively coupled via a local data network, wherein one or more of the operator station and the presenter station are communicatively coupled to the one or more target devices via a production router.

6. The integrated content-production system of claim 1, wherein the operator station is operable by a single operator and the presenter station is operable by a single presenter.
